(19) United States
(12) Patent Application Publication
(10) Pub. No.: US 2006/0132314 A1
(43) Pub. Date: Jun. 22, 2006

(54) Safety alarm for use with footwear

(76) Inventor: Sokrethya Sok, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/003,838

(22) Filed: Dec. 6, 2004

(51) Int. Cl. G08B 23/00

(52) U.S. Cl. 340/573.1

(57) ABSTRACT

This invention discloses an emergency alarm device that can be installed in footwear of all types. This device can be activated by the wearer of the footwear who is in danger or emergency situation and is in need of help from other persons. The wearer simply pushing to “ON” a safety switch on a hand held remote control or on the back of the footwear heel or on both sides to cause a water-proof electrical circuit within the footwear to operate using power from a battery. This electrical power is converted into sound energy and then sent to an audio amplifier or a speaker, generating a loud alarm of approximately 100 decibels per 1 shoe. The sound of alarm can be immediately deactivated by reinserting the safety mechanism back in its original place.

### FIELD OF THE INVENTION

This invention relates to new and useful improvements for footwear. More particularly, the present invention relates to footwear with an audible alarm that can be activated by the person wearing the footwear wherein when the alarm is activated it emits an alarm that will sound an acoustic alarm signal, which in turn will attract the attention of others in the vicinity.

### BACKGROUND OF THE INVENTION

Subconsciously everyone fears the unexpected and wants to feel secure as they go about their daily life. More than ever these days, people fear for their personal safety. Many people are constantly thinking of new ways of protecting themselves as they return home from work, are out shopping or enjoying themselves away from the safety of their homes. Emergency alarms are usually installed in automobiles or on doors. Example of such devices is a burglar alarm characteristically of a box shape (about twice as large as a pager). However, the emergency alarm device of this invention is small and compact in size and can be installed in footwear. This compact design makes it very convenient to use, since most people wear footwear all the time for in such activities as going to work, school, exercise or when they perform sports. In an emergency situation or a situation of threatening dangers occurring at night, the wearer of a footwear with an emergency alarm device of this invention can send an alarm to request help by simply pushing the safety switch on the shoe from “OFF” to “ON” to make the electrical circuit inside the footwear operate. Sound alarm products have been made that can be carried in a purse, but locating the product in an emergency can be difficult.

What is needed is an alarm device that is always ready to be used where a person can press a button and sound an alarm for help or to frighten an attacker. The ideal device would be located in something a person wears like footwear or shoes and as is always ready in case of an emergency. By just pressing the safety switch on the footwear or on a remote control will sound an acoustic alarm signal, which in turn attract the attention of others in the vicinity. Several products have been patented that try to address this need.

U.S. Pat. No. 4,352,853 issued to Ganyard on Sep. 21, 1982 discloses an alarm toe switch. This patent covers an alarm that is intended for use in a covert manner. The footwear and switch allows the person to activate the switch and alarm without being noticed. The alarm signals people that are not located near the person wearing the footwear. When the switch and alarm is activated people or authorities that are distal from the person wearing the footwear are notified, and can provide assistance. While this patent covers a footwear alarm, it does not provide an alarm that can be heard by people near the alarm to scare away attackers.

U.S. Pat. No. 5,235,761 issued to Chang on Aug. 17, 1993 discloses multi-purpose elastic footwear. The footwear provides the basic purpose of providing an alarm, but it also provides lights, and melodies. The patent allows the use to select one of the three or more functions for the footwear. The invention does not provide for a safety switch or remote control that reduces the possibility of accidental activation of the alarm, allows the person to start the alarm from a remote control.

U.S. Pat. No. 5,343,190 issued to Rodger on Aug. 30, 1994 discloses for signaling footwear. The signaling comprises a motion sensing mechanism that activates the signaling mechanism when the shoe is in motion. The signaling consists of lights and or sound that operate while the person is walking, or moving the footwear. While this patent covers making sound, the sound is intended for entertainment, and not for signaling an alarm.

What is needed is footwear that provides a simple to operate alarm that can scare away an attacker and bring help or assistance. The ideal alarm show would be waterproof, allow for easy battery replacement, have a safety mechanism that reduces accidental activation, and offer a remote switch that can activate the alarm. The proposed invention satisfies these requirements.

### BRIEF SUMMARY OF THE INVENTION

The object of the present invention is to provide an alarm that is located within footwear. The footwear alarm is intended for placement within standard footwear of nearly any style. The footwear alarm may also be a device that can be a replacement heel for footwear. The footwear may also include a safety interlock that reduces the possibility of accidental activation. Another feature of the footwear alarm is a remote control that can be used to activate the alarm in the footwear from a remote location.

The basic invention inside the footwear consists of micro-electronic component with an alarm that reaches ±100 dB, at a distance of approximately 100 meter. The alarm mechanism consists of an electrical circuit in the footwear that is waterproof. The circuit consists of a power supply with a removable or replaceable battery, safety catch for activating unit, oscillation mechanism and an audible sound device or speaker.

To be use, the activation mechanism on the footwear or on the remote control is pushed “ON” in an emergency situation to request help. This will sound the alarm and notify people that can hear the alarm that a person is in need of help or can be rescued.

### BRIEF DESCRIPTION OF THE DRAWINGS

FIG. 1 is an isometric view of a slip on type footwear with the safety alarm installed within the footwear.

FIG. 2 is an isometric view of sandal type footwear with the safety alarm installed within the footwear.

FIG. 3 is an isometric view of high heel type footwear with the safety alarm installed within the footwear.

FIG. 4 is a top view of a dress shoe with the safety alarm installed within the footwear.

FIG. 5 is an isometric view of an athletic shoe with the safety alarm with a remote control installed within the footwear.

FIG. 6 is a view of a schematic circuit for the safety alarm.

FIG. 7 is an isometric view of the safety alarm with the remote outside of a shoe.

FIG. 8 is a box diagram of the operation of the remote control unit and the safety alarm.

### DETAILED DESCRIPTION OF THE INVENTION

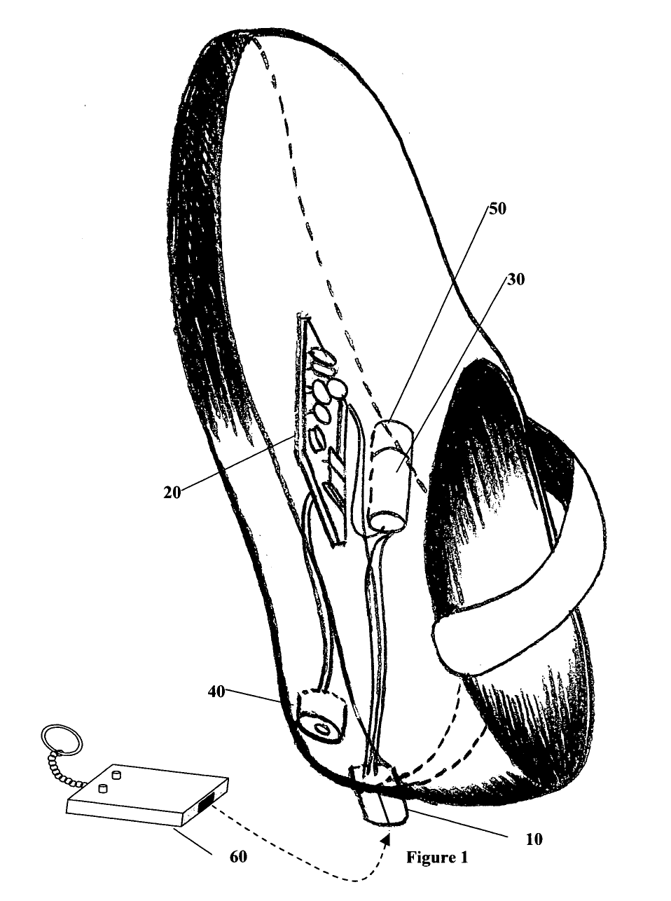

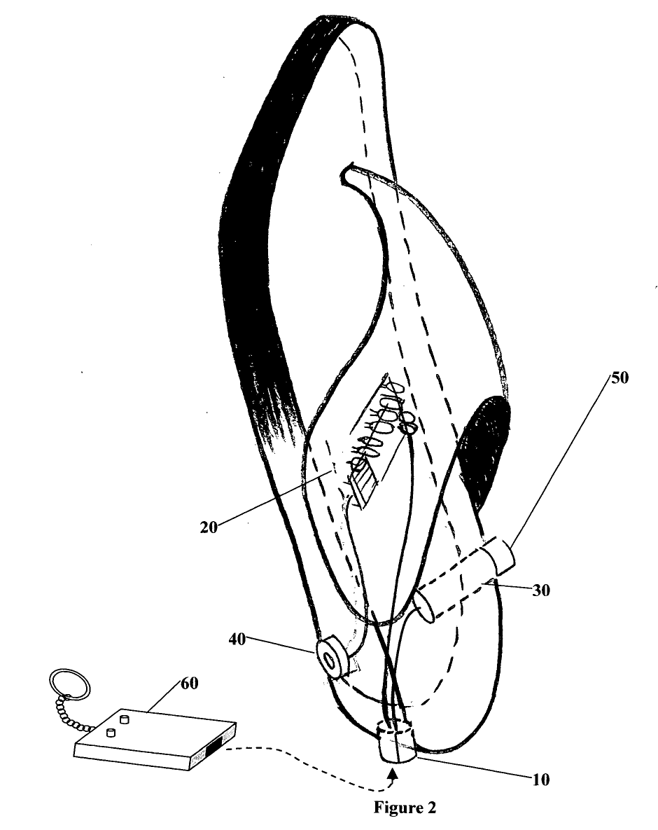

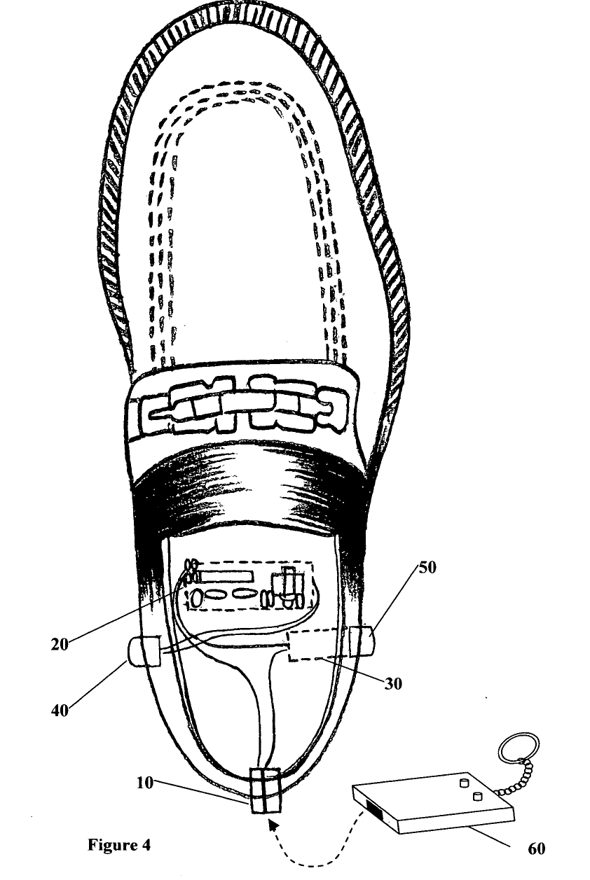

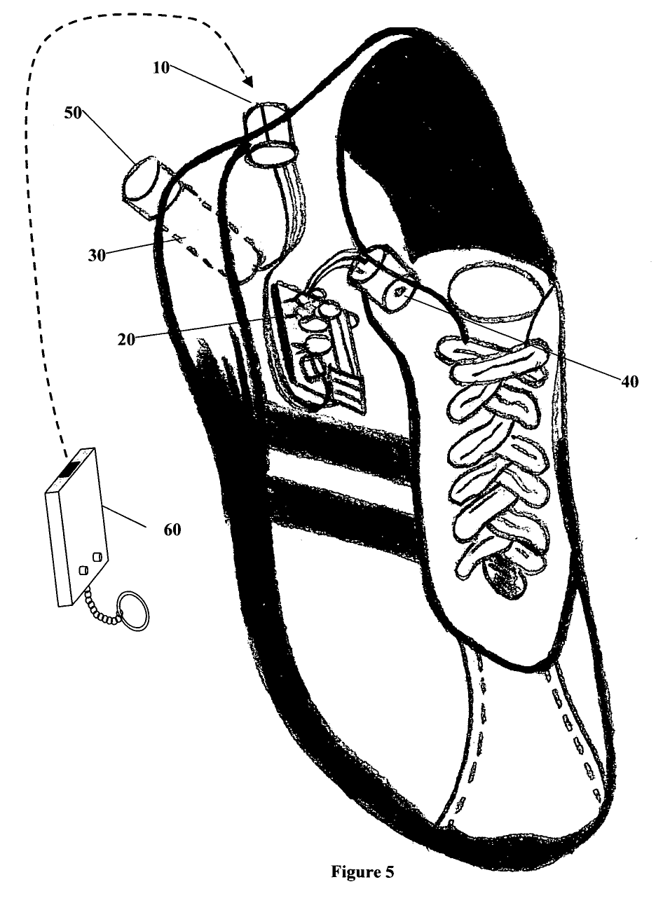

As shown in FIGS. 1-5 various configurations of foot covering articles of clothing or footwear are shown. In these figures integrated electronics are installed into the footwear. A more detailed description of the electronics will be covered in future figures, but from these figures the safety switch with a remote receiver 10 is shown where the user initiates the sounding of the alarm. Each of these figures shows the safety switch with the remote receiver located in the back of the footwear, but the safety switch with the remote receiver can be located on any side of the footwear. The switch is located in the back of the footwear for several reasons including reducing the possibility of activating the alarm, and ease of ability to activate the alarm in the case of an emergency.

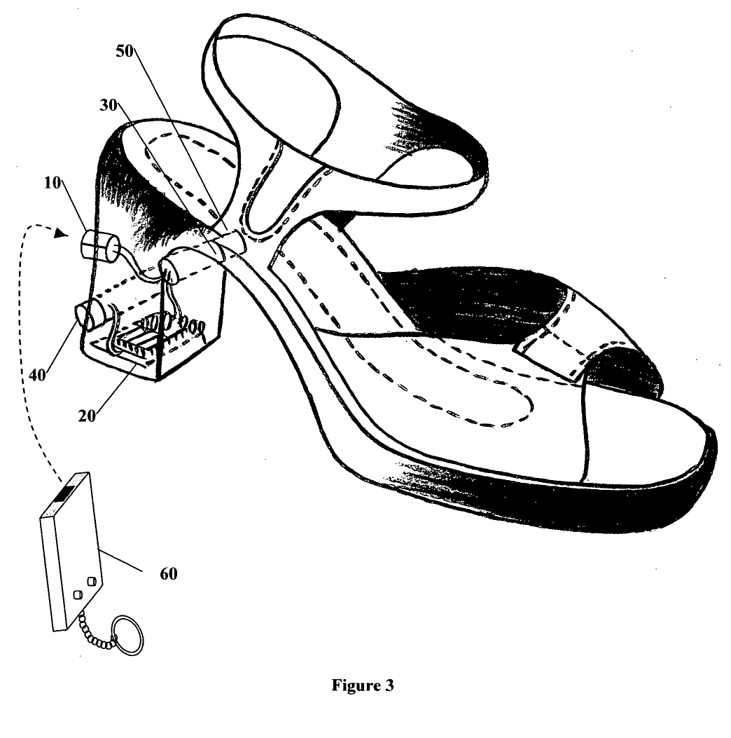

The electronics 20 that operate the alarm 40 are shown mounted within the footwear. These electronics are sealed, coated or protected from damage from water moisture or other contaminants that may exist on the ground. The electronics may also be molded into the shoe when the footwear is fabricated or can be located within a pre-formed cavity located in the bottom of the footwear. The electronics with all the remaining alarm components can be located in a replacement footwear heel that can be placed onto existing footwear. FIG. 3 shoes footwear with the electronics located within the lower portion of high-heal footwear. This can also be performed in dress footwear, or can be configured to located in the area between the heel and the pad of footwear. The footwear alarm that is added to existing footwear can be retained on the footwear with adhesives, Velcro or laced onto footwear. In this configuration, a single alarm can be transferred onto many type of footwear.

The alarm is powered by a single power source. In the preferred embodiment the power source is a 12V (R23) battery. This type of battery is a standard camera flash battery 30 that is available from a variety of stores. The battery is installed in a battery compartment 50 that can be opened on the side of the footwear. This battery compartment is also sealed from water or other contaminants that may damage the battery or the alarm mechanism. While the figures show the battery and the battery compartment located on the side of the footwear, these components can be located on any side of the footwear. They may also be located on the same side as the safety switch with remote receiver.

The speaker or transducer 40 is shown located at the side of the footwear to provide sound out of the side of the footwear. The speaker can be a variety of types that provide sound. In the preferred embodiment the transducer is a piezoelectric element. The piezoelectric device is used because they can emit a loud sound, and does not require a high amount of power to operate. The figure shows the speaker on one side of the footwear, but the speaker can be placed on any side of the footwear. The speaker is also show oriented to send sound horizontal to the footwear, but the speaker could be oriented in a vertical orientation, so the speaker can be larger in size.

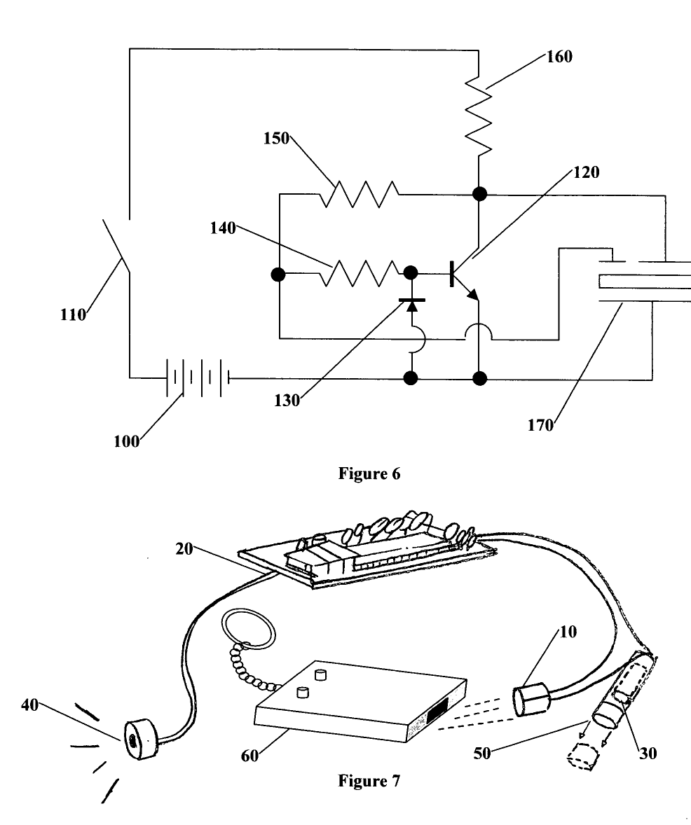

FIG. 6 shows one variation of the speaker drive electronics. This schematic utilizes a driving circuit for a self-drive type piezoelectric buzzer. From this figure the battery 100 is connected to a switch 110. When the switch is closed, power is supplied to the remainder of the circuit. A current limiting resistor 160 limits to amount of power to the circuit. A biasing resistor 150 set the turn on voltage for the transistor 120 that switches power to the buzzer 170. A resistor 140 limits the voltage to the gate of the transistor. A diode 130 blocks voltage to the transistor from exceeding the gate voltage. In a simpler contemplated embodiment the alarm consists of just the switch, battery and the buzzer. The emergency alarm can be activated immediately after the safety switch embedded in the footwear's heel is “ON”. The water-proof electrical circuit embedded in the footwear's sole start working after the safety switch is “ON” by drawing power from a battery embedded in the inner heel. The footwear wearer can conveniently and quickly replace this battery.

FIG. 7 shows the electronic components located outside of the footwear. From this figure, the components are easily seen. The circuit board containing the drive electronics 20 is shown in this figure with the speaker 40, and the safety switch with a remote receiver 10 and the battery 30 inside the battery housing 50.

In another embodiment the circuit consists of a more intelligent activation mechanism where the safety switch in the remote receiver is connected to a time delay circuit or a microprocessor that de-bounces and or requires that the switch be closed for a period of time such as a second or more before the alarm begins to sound. The circuit may further include a timer circuit that allows the alarm to sound for a period of time that could be a fixed or variable duration of several seconds to several minutes regardless of the condition of the safety switch or the remote control transmitter and receiver.

The remote control 60 shown in FIG. 1 and 7 works like a wireless switch. When the switch on the remote control unit is operated the remote control unit sends a wireless command to the receiver. The wireless command can operate in the radio or TV frequencies or other frequency bands. The wireless transmitter may also operate as an infrared or ultrasonic transmitter. In the preferred embodiment the transmitter operated in the UHF frequency. The remote control operates Instead of requiring the user to press a button on the shoe. The control sends an on/off signal from the transmitter to the receiver to control an electronic circuit 20 that generates the alarm sound. The remote control can have a one or more button that may have different function such as activating, de-activating and delayed activation. In one embodiment when the button is held down for more that one second the alarm will sound. When the button is pressed briefly the alarm will shut-off. If the button is pressed twice the alarm will sound in ten or more seconds. Other combinations are possible using one two or more buttons or a combination of buttons. It is also contemplated that the shoe alarm remote be programmed to operate with a car alarm or other remote control device.

When the circuit for the remote control sends an on or off signal, the receiver will trigger a relay and connect power from the batteries or power supply to the sound generator circuit. The sound generating circuit will then operate the speaker or sound-making device. Prototypes have been made using a normally open relay. When operated with the remote control is operated the normally open relay closes the circuit and operates the sound-making portion of the alarm. In another contemplated embodiment the alarm can consist of a pre-recorded message that can make a statement such as “HELP HELP” or if the person has a medical condition, the alarm may say “I NEED MEDICIAL HELP CALL 911”.

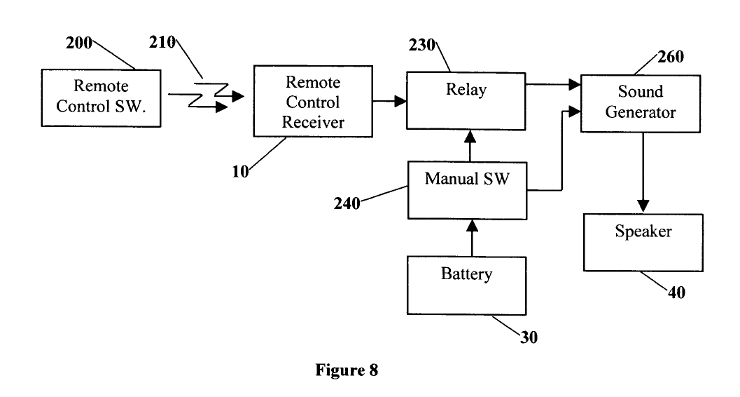

FIG. 8 shows a box diagram of the operation of the remote control unit and the safety alarm. From this figure the remote control switch 200 is located in the remote control unit shown as item 60 in FIGS. 1 to 7. When a button or a combination of buttons are pressed on the remote control unit. The remote control sends a wireless command 210 the remote control receiver 10. The remote control receiver activates a relay 230. The relay can also be activated with the manual switch 240. When the relay and/or the manual switch are activated the sound generator 260 will begin to generate sound. The sound generator is connected to a speaker 40. The power source or battery 30 is connected to the mechanism to supply power to the shoe alarm components. Components 10, 230, 240, 30, 260, and 40 are all located within the footwear.

As previously discussed the alarm or buzzer can be a variety of types. In the preferred embodiment of the alarm, samples have been made that reaches ±100 dB, at a distance of approximately 100 meter.

The safety switch can be a variety of types that reduce the possibility of accidental activation, but also allow easy activation is the case of an emergency. The switch must provide high reliability and must not be affected by contaminants such as water or dirt. In another contemplated embodiment the activation of the alarm can be made from pressing a remote activation switch that provides a wireless link to the footwear alarm. In one embodiment, the safety switch allows the operator to rotate the switch to arm the switch and then depress the switch to activate the alarm. The safety switch may also require a de-activation sequence to silence the alarm. In one contemplated de-activation sequence, the sequence may include both pulling out the switch and rotating the switch to stop the alarm from sounding.

The footwear alarm comprises of a shoe or other similar foot covering or protecting article that contains a sound producing mechanism integrated within the footwear. To activate the sound producing alarm, a switch or similar activating mechanism is depressed, turned, removed, altered to enable the sounding mechanism. The footwear can be any type of shoe such as sandals, high-heel shoes, athletic shoes. The sound producing mechanism is integrated in to the footwear and is over-molded, conformal coated, or otherwise protected from water or other elements that may cause damage or undesirable performance from the alarm mechanism. The switch that activates the alarm can consist of a momentary switch, multi-position switch, a removable activation safety mechanism or operate with a remote control transmitter and receiver. The activation mechanism may be a wireless or wired remote control that is separate from the footwear. In the preferred embodiment, power to the alarm is supplied with a sealed replaceable power source.

In another embodiment of the invention the footwear alarm is a separate unit that can be installed onto an existing article of footwear. The separate footwear alarm can be installed onto the footwear as a replacement heel, or can be attached to the underside of the footwear. The attachment location of the separate alarm can be in the location between the heel and the ball of the foot. Another potential attachment location can allow the alarm to wrap around the heel of the shoe. It is also contemplated that the separated footwear alarm is laced into the top of a shoe. The attachment of the separate footwear alarm can be from a variety of methods including but not limited to glue, adhesives, nails, screws, brads or something other than glue, adhesives, nails, screws, or brads.

Thus, specific embodiments and applications for footwear with an integrated alarm have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An emergency alarm device comprising:
footwear with;
an integrated sound producing mechanism located within the footwear, and
an activating mechanism connected to the sound producing mechanism to enable the sound producing mechanism.

2. The foot covering article of clothing according to claim 1 wherein the footwear is selected from a group consisting of shoes, sandals, high-heel shoes, athletic shoes.

3. The integrated sound producing mechanism from claim 1 wherein the sound producing mechanism is waterproof.

4. The activating mechanism from claim 1 wherein the activating mechanism consists of a momentary switch, multi-position switch, and removable activation safety mechanism.

5. The alarm device from claim 1 further includes a replaceable power source.

6. The alarm device according to claim 1 further includes a safety interlock that requires the activation device to be operated for more than one second to begin sounding.

7. The alarm according to claim 1 wherein once the alarm begins to sound, the alarm will sound for a limited period of time.

8. The activation mechanism from claim 1 wherein the activation mechanism is a remote control that has a wireless link to the alarm mechanism.

9. The remote control from claim 9 wherein the receiver for the remote control is located within the footwear.

10. An emergency alarm device comprising:
a footwear with;
an integrated sound producing mechanism, and
a first activating mechanisms located within the footwear and a second activating mechanism located externally from the footwear, and
a sound producing mechanism located within the footwear.

11. The footwear according to claim 10 wherein the footwear is selected from a group consisting of shoes, sandals, high-heel shoes, athletic shoes.

12. The integrated sound producing mechanism from claim 10 wherein the sound producing mechanism is waterproof.

13. The first activating mechanism from claim 10 wherein the first activating mechanism consists of a momentary switch, multi-position switch, and removable activation safety mechanism.

14. The alarm device from claim 10 further includes a replaceable power source.

15. The alarm device according to claim 10 further includes a safety interlock that requires either activation mechanism to be operated for more than one second to begin sounding.

16. The alarm according to claim 10 wherein once the alarm begins to sound, the alarm will sound for a limited period of time

17. The second activating mechanism from claim 10 wherein the activating mechanism uses a wireless communication link.

18. The wireless link from claim 17 wherein the link uses radio waves, ultrasonic, infrared or something other than radio waves, ultrasonic and infrared.

19. The second activating mechanism from claim 10 wherein the second activation mechanism is a hand held remote control.

20. The second activating mechanism from claim 19 allows for both an activating and a de-activating functions.
